(19) United States
(12) Patent Application Publication
(10) Pub. No.: US 2006/0092865 A1
(43) Pub. Date: May 4, 2006

(54) Supporting wireless communication interoperability compatibility with existing communications infrastructure

(75) Inventor: Terry L. Williams, Melbourne Beach, FL (US)

Correspondence Address: SACCO & ASSOCIATES, PA, P.O. BOX 30999, PALM BEACH GARDENS, FL, 33420-0999, US

(73) Assignee: AIRNET COMMUNICATIONS CORPORATION, Melbourne, FL (US)

(21) Appl. No.: 10/980,044

(22) Filed: Nov. 3, 2004

(51) Int. Cl. H04B 7/00

(52) U.S. Cl. 370/310

(57) ABSTRACT

The invention can include a base station for use with a land mobile radio network. The base station can include a controller (225) selecting an initial communication protocol and at least one target communication protocol that is different from the initial communication protocol. The base station also can include one or more transceivers (205, 210, 215) configured to send and receive a communication within a particular frequency band. The transceiver(s) can receive a communication formatted according to the initial communication protocol. A waveform processor (220) can be programmatically configurable to translate the communication to the target communication protocol(s) and format the communication as a communication originating from a mobile radio. The translated communication can be transmitted through the transceiver(s) to a node of a target communication network.

### BACKGROUND OF THE INVENTION

1. Field of the Invention

The present invention relates generally to wireless communications and, more particularly, to facilitating interoperability among disparate wireless systems and/or wireless infrastructure.

2. Description of Related Art

Communications interoperability is a significant issue that plagues many public safety agencies. Recent events have emphasized the need for multiple agencies to work together to meet modern day threats and challenges. For example, disaster recovery, whether in response to a natural disaster or a terrorist act, requires a multi-agency response to adequately deal with the consequences that may ensue.

Many agencies, such as police, fire, emergency medical responders, and the like have been building their own Land Mobile Radio (LMR) networks for some time. Until recently, however, communications interoperability was not considered a major issue. Each agency and/or municipality typically procured a communication system that fit its own budget and met its specific organizational needs. As a result, many of the LMR networks presently used by various agencies and governmental organizations are dissimilar and lack the ability to communicate with one another.

LMR networks can be implemented using any of a variety of different design options. It is precisely these options that prevent interoperability among different LMR networks. One design option pertains to the type of base station and/or repeater used. For example, different varieties of base stations and repeaters can include trunked or non-trunked systems, broadcast systems such as simulcast or multicast varieties, voting receiver systems, and zone systems. Within each respective category, subcategories may exist. For instance, the Association of Public-Safety Communications Officials, International (APCO) has set forth standards for trunked systems referred to as Project 16 (APCO 16) and Project 25 (APCO 25). EDACS® and OPENSKY® are other examples of different types of trunked LMR networks. Each variety of LMR network, however, is unable to communicate with the others.

Another difference among LMR networks is the frequency band in which the LMR network operates. LMR networks can vary significantly with respect to the portion of spectrum used. Available spectrum can include, but is not limited to, UHF, VHF, low VHF, and the 800 MHz band supporting full duplex communication. LMR networks operating in different frequency bands, however, are unable to communicate with one another. Thus, a UHF LMR network, for example, cannot communicate with a VHF LMR network.

LMR networks also utilize a variety of different radio channelizations, modulation schemes, and transmission modes. Regarding channelization, LMR waveforms in use today typically are wideband having a 25 kHz bandwidth or narrowband having a 12.5 kHz bandwidth. Other systems, such as P25 systems, utilize a 6.25 kHz channelization. Still, additional channelizations are under development and consideration. The modulation scheme used typically is frequency modulation (FM), which may be either analog or digital. Most 25 kHz channelized waveforms are digitally modulated using frequency shift keying (FSK). Finally, the mode of transmission, whether simplex, semi-duplex, or full duplex, can vary from one LMR network to another. A difference in any one of these options can prevent two LMR networks from communicating.

Replacing existing network infrastructure in an effort to eliminate these differences would be prohibitively expensive. Estimates for replacing disparate network infrastructure with interoperable infrastructure having features similar to the LMR equipment being replaced have been as high as $18 billion. This amount, however, is largely viewed as being low as it does not take into account expenses relating to training, adding data capabilities, or the cost of mobile equipment.

### SUMMARY OF THE INVENTION

The present invention relates to facilitating communications among disparate land mobile radio (LMR) systems. One aspect of the present invention can include a base station for use with a LMR network. The base station can include a controller configured to select an initial communication protocol and at least one target communication protocol. The initial communication protocol can be different from the target communication protocol(s). One or more transceivers and a waveform processor also can be included. The transceiver(s) can be configured to send and receive a communication within a particular frequency band. Thus, one of the transceivers can receive a communication formatted according to the initial communication protocol. The waveform processor can be programmatically configurable to translate the communication according to one or more target communication protocols.

The translated communication can be transmitted through the transceiver to a node of a target communication network, whether a base station, a repeater, another mobile radio, or the like. Regardless, the node of the target communication network can be configured to communicate using the target communication protocol(s). Notably, the communication also can be formatted as a communication originating from a mobile radio. Thus, the transmitted communication can be interpreted by the node of the target communication network as a communication originating from a mobile radio.

The base station can include a data store having one or more talk groups stored therein. A talk group can specify the initial and the target communication protocol(s). Accordingly, the controller can select the talk group from the data store. The waveform processor further can translate the communication according to at least a first and a second target communication protocol, wherein the first and second target communication protocols are different from one another. Each translated communication protocol can be transmitted through one or more transceivers.

In one embodiment, the base station can include a plurality of transceivers, each configured to send and receive communications within a particular frequency band. In that case, the waveform processor can translate the communication according to at least a first and a second target communication protocol. The first and second target communication protocols can be different from one another. The translated communication conforming to the first target communication protocol can be transmitted through one of the plurality of transceivers while the translated communication conforming to the second target communication protocol is transmitted through a different one of the plurality of transceivers.

The initial communication protocol and the target communication protocol(s) can differ by at least one of a frequency band, a radio channelization characteristic, a modulation scheme, and a transmission mode. In another arrangement, the base station and the node of the target communication network can differ by type. The various types can include, but are not limited to, trunked, non-trunked, broadcast, voting, and zone type systems.

Another aspect of the present invention can include a method of supporting interoperability among disparate communication networks within a base station. The method can include selecting an initial communication protocol and at least one target communication protocol that is different from the initial communication protocol. A communication formatted according to the initial communication protocol can be received. The method further can include translating the communication from the initial communication protocol to the target communication protocol(s) and formatting the translated communication as a mobile radio communication. The translated communication can be transmitted to a receiving node in a target communication network such that the translated communication is interpreted by the receiving node in the target communication network as a mobile radio communication.

The method further can include selecting the node of the target communication network to be at least one of a base station, a repeater, and a mobile radio. The node of the target communication network can be configured to communicate using the target communication protocol. The translating step can include translating the communication into at least two different target communication protocols. In that case, the transmitting step can include transmitting each translated communication through a different transceiver. The step of selecting an initial and target communication protocol can include accessing a talk group from a data store. The talk group can specify the initial communication protocol and the target communication protocol.

Notably, the initial communication protocol and the target communication protocol(s) can differ by at least one of a frequency band, a radio channelization characteristic, a modulation scheme, and a transmission mode. In one arrangement, the base station and the node of the target communication network can differ by type. For example, different types can include, but are not limited to, trunked, non-trunked, broadcast, voting, and zone type systems.

Another aspect of the present invention can include a machine readable storage, having a computer program having a plurality of code sections executable by one or more components of a base station within a communication network. The machine readable storage can cause the base station to perform one or more of the various steps described herein.

### BRIEF DESCRIPTION OF THE DRAWINGS

FIG. 1 is a schematic diagram illustrating disparate land mobile radio (LMR) networks communicating with one another in accordance with one embodiment of the present invention.

FIG. 2 is a schematic diagram illustrating one embodiment of a software defined radio-type base station of the variety described with reference to FIG. 1.

FIG. 3 is a flow chart illustrating a method of supporting interoperability among disparate LMR networks in accordance with another embodiment of the present invention.

### DETAILED DESCRIPTION OF THE INVENTION

The present invention provides a solution for communications interoperability. In particular, the present invention facilitates the interoperability of disparate communication systems, particularly Land Mobile Radio (LMR) networks, through the use of software defined radio (SDR) technology. In accordance with the inventive arrangements disclosed herein, a base station within a home LMR network can be configured to support communications with a variety of target LMR networks using different communication protocols.

Communications received by a base station configured in accordance with the inventive arrangements can be translated to a different communication protocol used by one of the target LMR networks. The communications can be formatted as communications originating from a mobile radio belonging to the target LMR network. That is, a base station configured as described herein generally emulates a mobile radio. A mobile radio, as used herein, can include any of a variety of different portable radio, whether a handset radio carried by an individual user or a radio intended for inclusion within a larger system such as a vehicle.

The translated communications are then transmitted to a node of the target LMR network. Due to the formatting and/or translation, the receiving node within the target LMR network views the received communications as if from a mobile radio within that node's own network, rather than from an out-of-network node. Thus, inclusion of a base station configured as disclosed herein within a home network allows mobile radio users within the home network to communicate with users in a target network. Significantly, this inter-LMR network communication can be achieved without any additional hardware and/or software modifications within the target LMR network. Moreover, establishing such communication requires no interference by administrative personnel within the target LMR network. The only network modifications necessary are implemented within the home LMR network.

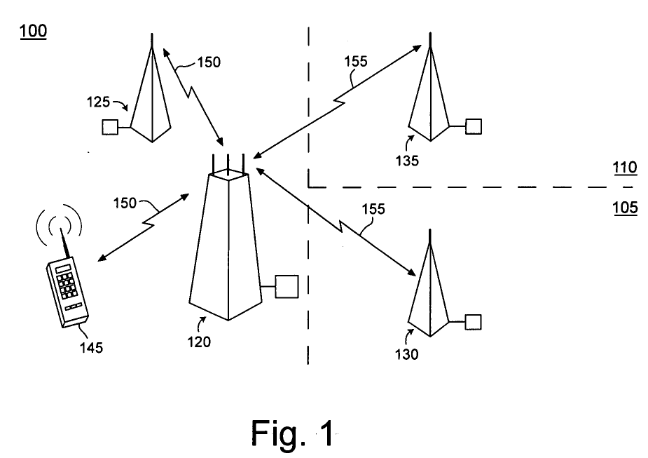

FIG. 1 is a schematic diagram illustrating disparate LMR networks 100, 105, and 110 communicating with one another in accordance with one embodiment of the present invention. In one aspect of the present invention, each of the LMR networks 100, 105, and 110 can be geographically distinct from one another and occupy a different geographic area. As such, the nodes of each LMR network may be disposed within the geographic area belonging to that network.

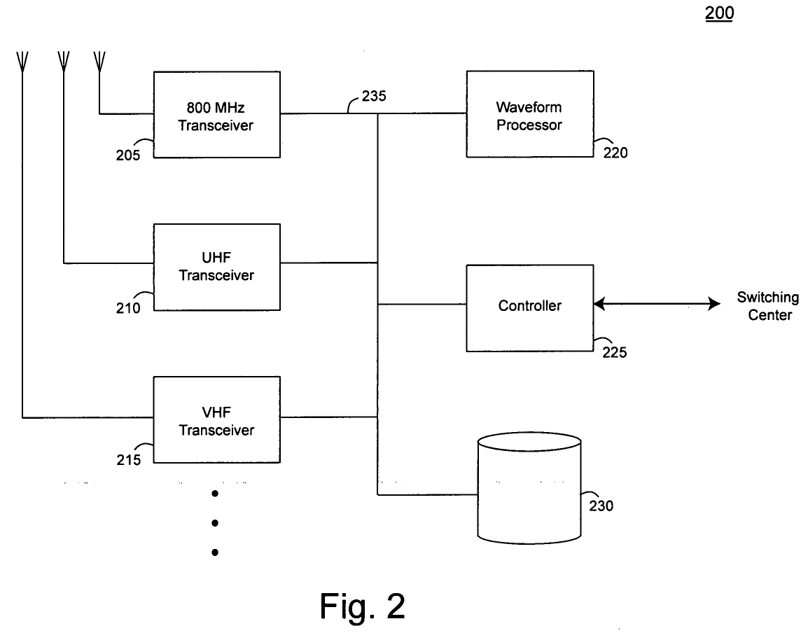

As shown, LMR network 100, called the home LMR network, can include a base station 120 incorporating software defined radio (SDR) technology and a conventional base station 125. Similarly, LMR networks 105 and 110 can include conventional base stations 130 and 135 respectively. As known, each conventional base station 125, 130, and 135 can include an antenna, a transceiver, one or more signal processors, and a signal amplification system. Base station 120 will be described in further detail with reference to FIG. 2.

For purposes of illustration, the LMR networks 105 and 110 are shown to include a single base station. It should be appreciated that each of the LMR networks 105 and 110 can include additional base stations, repeaters, one or more wireless mobile radios, and/or other network nodes as may be necessary. Likewise, LMR network 100 can include additional network nodes, such as a mobile radio 145, depending upon the particular network implementation used. As such, the embodiment depicted in FIG. 1 is not to be construed as a limitation of the present invention.

As used herein, the term “communication protocol” can refer to a group of attributes that characterize signals within a communication network. These attributes, which can vary from one LMR network to another, can include, but are not limited to, frequency band of operation, type of network node, modulation scheme, radio channelization, and transmission mode. Examples of different frequency bands can include, but are not limited to, VHF, UHF, 800 MHz, and the like. Different types of network nodes such as base stations, repeaters, and/or mobile radios can include, but are not limited to, trunked, non-trunked, broadcast including simulcast or multicast, voting, and zone type systems. Radio channelization refers to the waveform of a signal such as whether the signal is narrowband, wideband, formatted according to P25, or the like. Transmission mode refers to whether the network is broadcast, zoned, simulcast, or multicast.

Target LMR networks 105 and 110 can be configured to communicate using a particular or single communication protocol that is different from the communication protocol used in the home LMR network 100. Further, the communication protocol used by each of target LMR networks 105 and 110 need not be the same. In illustration, LMR network 105 can be configured to communicate using wideband, 800 MHz, FM signals. Further, LMR network 105 can be trunked. LMR network 110, however, can be configured to communicate using narrowband UHF signals. In contrast to LMR network 105, LMR network 110 can be non-trunked and use digital FM or frequency shift keying modulation.

It should be appreciated that the attributes noted herein are not intended as an exhaustive listing, but rather as examples intended to broaden the scope of the present invention. Indeed, any attribute of a communication system or signal that may be controlled via software, for example within the context of a SDR, can be a parameter or characteristic of a communication system that is included within the meaning of a communication protocol.

Within the home LMR network 100, base station 120 can incorporate SDR technology to support a plurality of different communication protocols. Thus, while other nodes in the home LMR network 100 can be configured to communicate using a particular or single communication protocol, base station 120 can be configured to translate signals or communications among a variety of disparate communication protocols.

Typically conventional base stations, such as base stations 130 and 135, are not configured to communicate with base stations in other or neighboring LMR networks. Base station 120, however, can communicate with base station 125 and mobile radio 145 within the same network using a same home communication protocol. By effectively emulating a mobile radio, base station 120 also can communicate with LMR networks 105 and 110 using the communication protocol of each respective target LMR network. Thus, base station 120 effectively serves as a link or intermediary to base stations 130 and 135 within the disparate LMR networks 105 and 110 respectively. Notwithstanding, base station 120 further can communicate with mobile radios (not shown) belonging to each of target LMR networks 105 and 110.

In operation, base station 120 can receive a communication 150 from mobile radio 145 or base station 125. Communication 150 can be formatted according to the communication protocol used within the home LMR network 100. For example, communication 150 can be a narrowband, FM, low VHF signal. Communication 150 can be translated from this initial communication protocol used by the home LMR network 100 to a communication protocol used by one or more target LMR networks.

Thus, if the communication is to be transmitted to target LMR network 105, communication 150 can be translated to a wideband, 800 MHz, FM signal. If communication 150 is to be transmitted to target LMR network 110, communication 150 can be translated into a narrowband, digitally modulated, UHF signal. Notably, a same communication can be translated to one or more different protocols. Each differently translated communication also can be transmitted to one or more different target LMR networks in accordance with the communication protocol used in that target LMR network. Such communications, for example communication(s) 155, can be sent concurrently, nearly concurrently, or in serial fashion. Communication protocol translation is discussed within application Ser. No. 10/078,783, filed Feb. 19, 2002. This application, which is entitled “Software-Defined Radio Communication Protocol Translator”, is fully incorporated herein by reference.

The base station 120 can be programmed with one or more talk groups, each defining a grouping of disparate LMR networks that may communicate with the home LMR network. Each talk group further specifies the communication protocols that must be translated to do so. The talk groups are configured by administrative personnel that have access to the base station 120 and can be activated upon request of a mobile radio user within the home LMR network 100.

In addition to translating the communication from one communication protocol to another, outgoing communication(s) 155 from the base station 120 can be formatted as if being sent from a mobile radio. Thus, when communication 155 is received by a node in a target LMR network, communication 155 appears as though it originated from a mobile radio within, or belonging to, that target LMR network, rather than as a communication from a base station disposed in the home LMR network 100. Such formatting also can be specified by a relevant talk group.

Thus, by including a base station 120 as described herein, the home LMR network 100 can communicate with a variety of disparate target LMR networks. By emulating a handset, nodes within the target LMR networks 105 and 110, i.e. base stations 130 and 135, can receive and process communications from the base station 120 without any modification to the nodes of the target LMR network(s). As noted, no intervention or system reprogramming on the part of administrative personnel within the target LMR networks 105 and 110 is required.

FIG. 2 is a schematic diagram illustrating one embodiment of a SDR-type base station (SDR base station) 200 of the variety described with reference to FIG. 1. The SDR base station 200 provides software control over a variety of radio communication operating parameters such as frequency, modulation techniques, communications security functions, and waveform requirements. The fact that these parameters are determined through software means that the SDR base station 200 can be programmed to transmit and receive on any frequencies and to use any desired transmission modulation, coding, and information formats within the limits of its design. This affords the SDR base station 200 substantial flexibility to communicate with multiple target LMR networks.

As shown, the SDR base station 200 can include a plurality of transceivers 205, 210, and 215, a waveform processor 220, a controller 225, and a data store 230. Each of the components of the SDR base station 200 can be communicatively linked with one another via a communications bus 235 or other suitable circuitry. Each of the transceivers 205-215 can be a wideband transceiver configured to send and receive signals for a particular frequency band. For example, as shown, transceiver 205 can be a wideband transceiver operating in the 800 MHz frequency band. Transceiver 210 can operate in the UHF frequency band while transceiver 215 can operate in the VHF frequency band. Additional or fewer transceivers may be included as the present invention is not limited by the specific number, or variety, of transceivers included. A suitable transceiver can be included for each frequency band of interest. That is, transceivers can be included for each frequency band over which communications are to be sent or received.

In any case, the transceivers 205-215 can be agnostic with respect to the particular type of communication protocol of received and/or transmitted communications. More particularly, each transceiver 205-215 can send and receive signals regardless of waveform type, channelization, modulation scheme, and/or transmission mode. Thus, each transceiver can send and receive any of a variety of differently formatted signals so long as the signal, or communication, is located within the frequency band of the transceiver.

One variety of transceiver that can be used with the present invention can include a receive channel having a pre-amplification stage, a frequency down-conversion stage, and an analog-to-digital (A/D) stage. Received signals can be amplified and/or conditioned through the pre-amplification stage and then down-converted to an intermediate frequency (IF). At that point, the signal can be converted to a digitized signal for processing. Once digitized, the signals can be filtered, demodulated, and the like using appropriate computer programs executing within, for example, the waveform processor 220.

With respect to signal transmission, the transceivers can include a digital-to-analog (D/A) conversion stage, a frequency up-conversion stage, and an amplification stage. Digitized signals that may be manipulated under software control with respect to modulation, filtering, and the like can be received by the transceiver from the waveform processor 220. The digitized signals can be converted to analog signals at the IF. The resulting analog signals can be up-converted from the IF to the proper frequency and provided to the amplification stage for transmission.

It should be appreciated, however, that other transceiver configurations can be used with the present invention. As such, the SDR base station 200 should not be limited solely to the transceiver configurations disclosed herein. For example, depending upon the frequency of received signals, the transceiver need not down-convert such signals to an IF prior to digitization. In that case, the transceiver can include a pre-amplification stage connected directly to an A/D stage. Similarly, the transmission portion need not include an up-conversion stage.

The waveform processor 220 can be implemented as one or more processors, digital signal processors, controllers, or various combinations thereof. The waveform processor 220 performs translations between various communication protocols. Received communications can be reformatted into a different communication protocol prior to being transmitted. To process communications and perform communication protocol translations, the waveform processor 220 can run any of a variety of different computer programs and/or algorithms under the control of the controller 225. Thus, the waveform processor 220 can implement different modulation and/or demodulation schemes, process different transmission modes and different radio channelizations, and down or up-convert signals to and from base band by executing an appropriate computer program and/or algorithm.

In one embodiment, translations can be performed by first translating the received communication into an intermediate format used within the SDR base station 200 and then translating the intermediate format to a communication protocol used by a target LMR network. For example, the communication can be demodulated and decoded and then converted into an intermediate format. From the intermediate format, the communication can be encoded using a different communication protocol and modulated for transmission.

In another embodiment, the translation can be performed directly from the communication protocol of the home LMR network to the communication protocol of the target LMR network. That is, the communication can be demodulated and decoded and then encoded using a different communication protocol and modulated for transmission. Regardless of the implementation used, it should be appreciated that such translations can be performed in reverse order as well. Communications from target LMR systems can be translated to the communication protocol of the home LMR network and transmitted to nodes within the home LMR network. In any case, the present invention is not to be limited by the particular manner in which the communication protocol translations are performed.

Another function of the waveform processor 220 is to format selected outgoing communications as mobile radio communications. More particularly, a communication received from the home LMR network that is to be transmitted to a target LMR network can be transmitted as a mobile radio communication. Because the communication is transmitted from the base station 200 with more power than would be possible using a mobile radio, communication channels can be established between the base station 200 and target LMR networks that are located at distances exceeding about 30 miles from the base station 200. Still, it should be appreciated that distances can vary as a consequence of frequency and other factors, and that the present invention is not so limited.

The base station 200 effectively emulates a mobile radio, thereby allowing a user within the home LMR network to communicate with one or more users located in one or more target LMR networks. By emulating a mobile radio, no intervention on the part of administrators of the target LMR network(s) is required. Such is the case as nodes in the target LMR network(s) process communications from the SDR base station 200 as if from a radio belonging to, or within, the target LMR network(s).

The controller 225 controls the operation of the waveform processor 220. The controller 225 instructs the waveform processor how to process signals received over the various transceivers 205-215, how to process signals for transmission, as well as dictate how signals are to be routed to and from the various transceivers 205-215. Information needed by the controller 225 in making these decisions is stored within the data store 230.

In addition to controlling the waveform processor 220, the controller 225 also serves as an interface between the base station 200 and other computer systems and/or network nodes. For example, administrative consoles located at a remote site, or at the same site as the SDR base station 200, can communicate and/or control functions of the SDR base station 200 by interfacing with the controller 225 through a landline network connection. Other network nodes such as switching systems also can be communicatively linked to the SDR base station 200 via the controller 225.

The data store 230 can be a dynamic memory, a magnetic storage medium, or any other suitable medium for storing data. While the data store 230 is shown as being distinct from the controller 225 and connected through the communications bus 235, it should be appreciated that data store 230 also can be embedded, or included, within the controller 225. Information specifying relationships between an initial communication protocol, one used in the home LMR network, and the communication protocol of one or more target LMR networks can be stored within the data store 230 for use as a particular talk group. Each talk group defines groupings of radio channels of disparate LMR networks that may communicate with the home LMR network and the communication protocols that must be translated to do so.

The talk groups stored in the data store 230 can be defined by a system administrator working at an administrative console that is communicatively linked with the base station 200 as described. Accordingly, talk groups can be defined on a permanent and/or temporary basis. Each talk group defines the particular processing, i.e. computer programs and/or algorithms, that must be applied by the waveform processor 220 to a received signal to transmit the communication to one or more target LMR networks. In addition, talk groups also can specify particular transceivers to be used in transmitting translated communications. The reverse process of receiving communications from one or more target LMR networks and processing those communications for transmission into the home LMR network also can be specified.

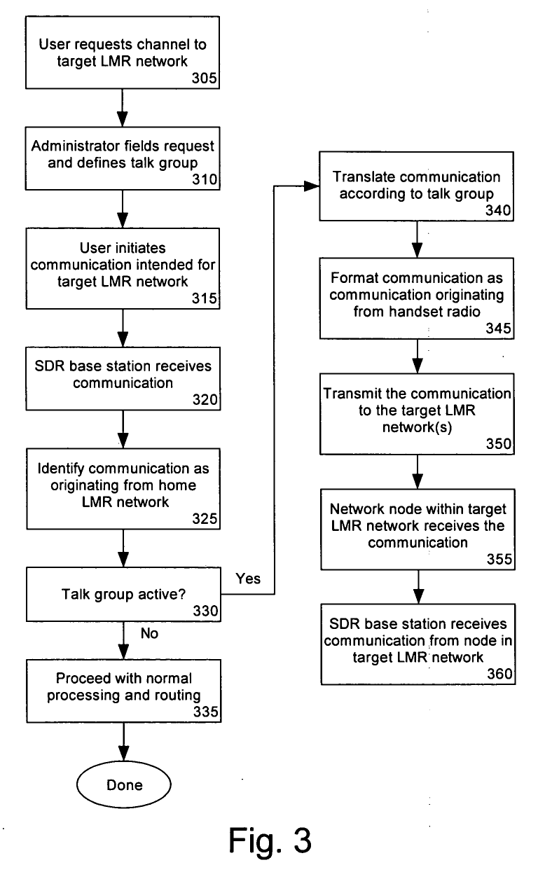

FIG. 3 is a flow chart illustrating a method of supporting interoperability among disparate LMR networks in accordance with one embodiment of the present invention. The methodology disclosed herein can be incorporated within a SDR base station, as described with reference to FIG. 2, and further facilitates the emulation of a mobile radio by such a base station. The method can begin in step 305 where a user within the home LMR network initiates a communication from a mobile radio. The user can request a communication channel with a different or target LMR network.

In step 310, responsive to the user request, an administrator within the home LMR network can field the user request. Through the administrative console, the administrator can define, or program, a talk group within the SDR base station. The talk group then can be activated. The talk group defines a grouping of the home LMR network and the different target LMR network(s) with which the user wishes to communicate. Further, the particular communication protocol used by each target LMR network can be specified.

In one embodiment, the administrative console and/or the SDR base station can include a listing of target LMR networks that are within communication range of the SDR base station as well as a listing of the communication protocol used by each. Such a configuration can aid administrators in constructing talk groups when communication channels with target LMR networks are requested by users. For example, a talk group may specify that the home LMR network is a narrowband, low VHF, FM system, while the target LMR network is a wideband, 800 MHz, FM system. If neighboring target LMR networks are preprogrammed as described, then one or more target LMR networks can be selected from a list for inclusion in the talk group.

In step 315, the user can initiate a communication intended for transmission to the target LMR network. In step 320, the communication can be received by the SDR base station. The communication can be received directly from the user's mobile radio or can be forwarded from another node in the home LMR network. In any case, in step 325, the communication can be identified as one originating from within the home LMR network.

In step 330, a determination can be made as to whether a talk group has been activated. If not, the method can proceed to step 335 where conventional processing and routing of the communication within the home LMR network can be performed. If a talk group has been activated, however, the method can proceed to step 340 where the translation process can begin. In step 340, the waveform processor can translate the received communication from the communication protocol used by the home LMR network to the communication protocol(s) of the target LMR network(s). More particularly, the communication can be demodulated and decoded according to the communication protocol of the home LMR network. The communication then can be encoded and modulated according to the communication protocol of the target LMR network(s) as defined by the talk group.

In step 345, the communication can be formatted to appear as a mobile radio communication. In other words, the communication is formatted to appear as a communication originating from a mobile radio that is disposed within, or belongs to, the target LMR network or networks. Such formatting is standardized and specified by the particular target communication protocol to be applied. For example, in one embodiment, formatting a communication as a mobile radio and/or handset communication can include altering, reformatting, and/or relocating header information and/or message data within the communication. Once complete, the resulting communication can specify, or identify itself, as one that has originated from a mobile radio. In another embodiment, such processing can transform the communication into a type that is traditionally reserved for a mobile radio or handset.

It should be appreciated, however, that any attribute of the communication can be altered and/or modified if such alteration or modification indicates that the communication originated from a mobile and/or handset radio. Such modification can be dependent upon the particular protocol used by the target LMR network. Examples of such attributes can include, but are not limited to, modulation scheme, timing, data, sub-carrier such as sub-audio, coding, frequency, channelization, and the like. As this listing is not intended to be exhaustive, any of the attributes of a communication described herein can be modified or formatted in a manner that is characteristic or indicative of a mobile radio communication.

It should be appreciated that while the formatting step has been shown as being independent of the translating step, both steps can be performed in combination with one another in parallel. For example, in one embodiment, communications can be demodulated and decoded. The communication then can be formatted as a mobile radio communication during encoding and modulation according to the communication protocol of the target LMR network.

In step 350, the communication can be transmitted to the target LMR network(s). In transmitting the communication, the controller can select the particular transceivers to be used in sending the translated communication to the target networks. Notably, such routing information can be stored within the controller and/or the data store. For example, in preprogramming communication protocol data, the frequency band of operation for each communication protocol can be stored and associated with a particular transceiver within the SDR base station.

In step 355, a network node within the target LMR network can receive the communication. Notably, if the node is a repeater or base station, the communication can be rebroadcast to one or more mobile radios within the target LMR network. Because the communication from the home LMR network appears as a mobile radio communication from within the target LMR network, no administrator intervention, hardware modifications, and/or software modifications are required within the target LMR network.

Similarly, in step 360, a communication from the target LMR network can be received by the SDR base station. The communication can be from a mobile radio, a base station, or another network node. This communication can be translated from the communication protocol used by the target LMR network to the communication protocol of the home LMR network. That is, the communication can be demodulated and decoded according to the communication protocol of the target LMR network. The communication then can be encoded and modulated according to the communication protocol of the home LMR network as defined by the talk group. As noted, the SDR base station can receive communications from more than one target network, translate those communications, and provide them to one or more mobile radios within the home network.

Once the communication channel between the home LMR network and the target LMR network(s) is established, users within both networks can communicate with one another as needed. The communication channel can be maintained for a predetermined amount of time, for example as specified by the talk group. Alternatively, or in combination, the communication channel can be terminated by an administrator when no longer needed.

As the method illustrated in FIG. 3 has been provided for purposes of illustration, it is not intended to be limiting with respect to the inventive arrangements disclosed herein. Other embodiments also are within the scope of the present invention. For example, in one embodiment, talk groups can be preprogrammed within the SDR base station. In that case, users in the home LMR system can activate selected talk groups by selecting a particular key sequence on a mobile radio. For instance, conventional dual-tone multi-frequency (DTMF) signals can be used for this purpose. When the SDR base station receives the key sequence, the selected talk group can be activated, thereby automatically creating a communication channel with one or more target LMR networks without any administrative intervention.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited.

Aspects of the present invention also can be embedded in a computer program product, which comprises all the features enabling the implementation of the methods described herein, and which when loaded in a computer system is able to carry out these methods. Computer program or application program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A base station for use with a land mobile radio network comprising:
a controller selecting an initial communication protocol and at least one target communication protocol that is different from the initial communication protocol;
at least one transceiver configured to send and receive a communication within a particular frequency band, wherein said at least one transceiver receives a communication formatted according to the initial communication protocol; and
a waveform processor programmatically configurable to translate the communication into the at least one target communication protocol, wherein the communication is formatted as a communication originating from a mobile radio,
wherein the translated communication is transmitted through the at least one transceiver to a node of a target communication network.

2. The base station of claim 1, wherein the transmitted communication is interpreted by the node of the target communication network as a communication originating from a mobile radio belonging to the target communication network.

3. The base station of claim 1, wherein the node of the target communication network is at least one of a base station, a repeater, and a mobile radio.

4. The base station of claim 1, wherein the node of the target communication network is configured to communicate using the at least one target communication protocol.

5. The base station of claim 1, further comprising a data store having at least one talk group stored therein, wherein the talk group specifies the initial and at least one target communication protocol, said controller selecting the talk group from said data store.

6. The base station of claim 1, wherein said waveform processor translates said communication into at least a first and a second target communication protocol, wherein said first and second target communication protocols are different from one another, and each translated communication is transmitted through said at least one transceiver.

7. The base station of claim 1, further comprising a plurality of transceivers, each configured to send and receive communications within a particular frequency band.

8. The base station of claim 7, wherein said waveform processor translates the communication into at least a first and a second target communication protocol, wherein the first and second target communication protocols are different from one another, wherein the translated communication conforming to the first target communication protocol is transmitted through one of said plurality of transceivers and a translated communication conforming to the second target communication protocol is transmitted through a different one of said plurality of transceivers.

9. The base station of claim 1, wherein the initial communication protocol and the at least one target communication protocol differ by at least one of a frequency band, a radio channelization characteristic, a modulation scheme, and a transmission mode.

10. The base station of claim 1, wherein said base station and the node of the target communication network differ by type.

11. The base station of claim 1, wherein the types are selected from the group consisting of trunked, non-trunked, broadcast, voting, and zone systems.

12. Within a base station, a method of supporting interoperability among disparate communication networks comprising:
selecting an initial communication protocol and at least one target communication protocol that is different from the initial communication protocol;
receiving a communication formatted according to the initial communication protocol;
translating the communication from the initial communication protocol to the at least one target communication protocol;
formatting the translated communication as a mobile radio communication; and
transmitting the translated communication to a receiving node in a target communication network, wherein the translated communication is interpreted by the receiving node in the target communication network as a mobile radio communication.

13. The method of claim 12, further comprising selecting the node of the different communication network to be at least one of a base station, a repeater, and a mobile radio.

14. The method of claim 12, wherein the node of the target communication network is configured to communicate using the at least one target communication protocol.

15. The method of claim 12, said translating step comprising translating the communication into at least two different target communication protocols.

16. The method of claim 15, said transmitting step further comprising transmitting each translated communication through a different transceiver.

17. The method of claim 12, wherein the initial communication protocol and the at least one target communication protocol differ by at least one of a frequency band, a radio channelization characteristic, a modulation scheme, and a transmission mode.

18. The method of claim 12, wherein said base station and the node of the target communication network differ by type.

19. The method of claim 12, wherein the types are selected from the group consisting of trunked, non-trunked, broadcast, voting, and zone systems.

20. The method of claim 12, said selecting step further comprising accessing a talk group from a data store, wherein the talk group specifies the initial communication protocol and the at least one target communication protocol.

21. A machine readable storage, having stored thereon a computer program having a plurality of code sections executable by one or more components of a base station within a communications network, causing the base station to perform the steps of:
selecting an initial communication protocol and at least one target communication protocol that is different from the initial communication protocol;
receiving a communication formatted according to the initial communication protocol;
translating the communication from the initial communication protocol to the at least one target communication protocol;
formatting the translated communication as a mobile radio communication; and
causing the translated communication to be transmitted to a receiving node in a target communication network, wherein the translated communication is interpreted by the receiving node in the target communication network as a mobile radio communication.

22. The machine readable storage of claim 21, said translating step comprising translating the communication into at least two different target communication protocols.

23. The machine readable storage of claim 22, said step of causing the translated communication to be transmitted further comprising selecting a first transceiver for transmitting a translated communication formatted according to a first of the at least two different target communication protocols and a second transceiver for transmitting a translated communication formatted according to a second of the at least two different target communication protocols.

24. The machine readable storage of 21, wherein the initial communication protocol and the at least one target communication protocol differ by at least one of a frequency band, a radio channelization characteristic, a modulation scheme, and a transmission mode.
